(19) United States
(12) Patent Application Publication
(10) Pub. No.: US 2023/0137995 A1
(43) Pub. Date: May 4, 2023

(54) INFORMATION PROCESSING METHOD, STORAGE MEDIUM, AND INFORMATION PROCESSING APPARATUS

(71) Applicant: Nozomu KUBOTA, Tokyo (JP)

(72) Inventor: Nozomu KUBOTA, Tokyo (JP)

(21) Appl. No.: 17/976,532

(22) Filed: Oct. 28, 2022

(30) Foreign Application Priority Data
Oct. 28, 2021 (JP) 2021-176197

(51) Int. Cl. G06N 3/048; G06F 18/24

(52) U.S. Cl. CPC G06N 3/048; G06F 18/24

(57) ABSTRACT

It is intended to provide a significant data expansion algorithm for predetermined data. An information processing method performed by a processor included in an information processing device, the method includes: acquiring expanded data resulting from expansion of target data using an optional data expansion algorithm including a coupled function obtained by coupling together a plurality of data expandable functions by using weights; implementing learning, the learning including implementing the learning by inputting the expanded data to a learning model that performs predetermined learning and implementing the learning by using each item of the expanded data generated by stepwise changing a weight of the coupled function; specifying a boundary weight with which a learning result of the learning indicates an intended result and associating the boundary weight with information related to the target data.

### BACKGROUND

### Field

The present invention relates to an information processing method, a recording medium, and an information processing device.

### Description of Related Art

In recent years, a technology that uses an image generated by using a generative adversarial network to expand training data has been known (see, e.g., CN111401445A Specification).

### SUMMARY

With regard to data expansion, at the time of input to a learning model, there is a need to perform data expansion so as to obtain an intended result (e.g., a correct classification result or an incorrect classification result). However, in some cases, even when data expansion is performed using an optional data expansion algorithm, the resulting data may be data different from data intended by a user. For example, when a thumb-up image representing “Good” is vertically inverted to a thumb-down image representing “Bad”, the meaning is completely reversed, and the intended result cannot be obtained.

Therefore, the present invention provides an information processing method, a recording medium, and an information processing device which allow a significant data expansion algorithm to be provided for predetermined data.

An information processing method according to an aspect of the present invention includes: a processor included in an information processing device acquiring expanded data resulting from expansion of target data using an optional data expansion algorithm including a coupled function obtained by coupling together a plurality of data expandable functions by using weights; the processor implementing learning, the learning including implementing the learning by inputting the expanded data to a learning model that performs predetermined learning and implementing the learning by using each item of the expanded data generated by stepwise changing a weight of the coupled function, and the processor specifying a boundary weight with which a learning result of the learning indicates an intended result and associating the boundary weight with information related to the target data.

An information processing method according to another aspect of the present invention includes: a processor included in an information processing device acquiring expanded data resulting from expansion of target data using an optional data expansion algorithm including a function that can be subjected to integral order or fractional order differentiation or integration; the processor implementing learning, the learning including implementing the learning by inputting the expanded data to a learning model that performs predetermined learning and implementing the learning by using each item of the expanded data generated by stepwise changing an integral order or a factional order of the function; and the processor specifying a boundary integral order or fractional order with which a learning result of the learning indicates an intended result and associating the boundary integral order or fractional order with information related to the target data.

According to the present invention, it is possible to provide an information processing method, a recording medium, and an information processing device which allow a significant data expansion algorithm to be provided for predetermined data.

### BRIEF DESCRIPTION OF DRAWINGS

FIG. 1 is a diagram illustrating an example of a system configuration according to an embodiment;

FIG. 2 is a diagram illustrating an example of a physical configuration of an information processing device according to the embodiment;

FIG. 3 is a diagram illustrating an example of processing blocks of a server according to the embodiment;

FIG. 4 is a diagram illustrating an example of processing blocks of the information processing device according to the embodiment;

FIG. 5 is a diagram illustrating an example of a function library according to the embodiment;

FIG. 6 is a diagram illustrating an example of association data of information related to target data and information related to a significant data expansion algorithm according to the embodiment;

FIG. 7 is a diagram illustrating an example of a predetermined range according to the embodiment;

FIG. 8 is a flow chart illustrating an example of processing by a server according to the embodiment; and

FIG. 9 is a flow chart illustrating an example of processing by an information processing device 20 according to the embodiment.

### DETAILED DESCRIPTION

Referring to the accompanying drawings, a description will be given of an embodiment of the present invention. Note that, throughout the individual drawings, components denoted by the same reference signs have the same or similar configurations.

System Configuration

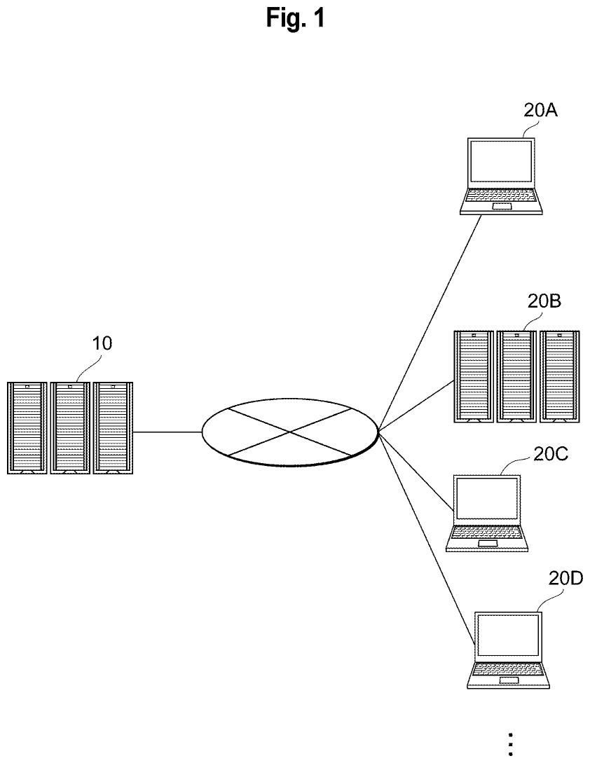

FIG. 1 is a diagram illustrating an example of a system configuration according to the embodiment. In the example illustrated in FIG. 1, a server 10 and each of information processing devices 20A, 20B, 20C, and 20D are connected via a network to be capable of data transmission/reception. In a case where the information processing devices are not individually distinguished from each other, each of the information processing devices is referred to also as an information processing device 20.

The server 10 is an information processing device capable of collecting and analyzing data, and may also be configured to include one or a plurality of information processing devices. The information processing device 20 is an information processing device capable of performing machine learning, such as a smartphone, a personal computer, a tablet terminal, a server, or a connected car. Note that the information processing device 20 may also be a device directly or indirectly connected to an invasive or non-invasive electrode that senses brain waves to be able to analyze and transmit/receive brain wave data.

In the system illustrated in FIG. 1, the server 10 associates, with each item of data, a data expansion algorithm (hereinbelow referred to also as a “significant data expansion algorithm”) that allows a user to obtain intended data. Accordingly, the server 10 uses various data expansion algorithms to expand target data and performs predetermined learning with respect to the data that has been expanded (hereinbelow referred to also as the “expanded data”) to acquire a learning result. When the learning result is an intended learning result, the server 10 associates the target data with the data expansion algorithm.

For example, the user who intends to increase training data including the target data and increase accuracy of a learning model uses the data expansion algorithm to generate the expanded data from the target data and increase the training data. At this time, when supervised learning is performed, annotation in which all expanded data items are labeled is consequently performed to increase labor of the user.

Meanwhile, when it is possible to perform data modification and expansion with respect to the manually labeled target data without changing the meaning of features of the target data, it is possible to assign, to the expanded data, the same label as that of the target data. Therefore, the technology of the present disclosure finds, on the basis of a result of learning the target data, a significant data expansion algorithm that provides an intended learning result set by the user, and associates the target data with the significant data expansion algorithm. The intended learning result may also include a result set by the user from among a plurality of results including a correct answer or an incorrect answer to a predetermined learning problem.

For example, when it is assumed that the target data is image data, the data expansion algorithms include processing such as inversion, brightness change, rotation, parallel shift, and synthesis, and all these algorithms can be mathematized and represented as functions. The mathematized functions are linearly coupled using weights or subjected to integral order or fractional order differentiation or integration to be able to increase the data expansion algorithms and complicate mathematical formulae. As a result, it is possible to increase an amount of the expanded data generated by the data expansion algorithms and contribute to an improvement in the accuracy of the learning model. A description will be given below of a configuration of each of the devices in the present embodiment.

Hardware Configuration

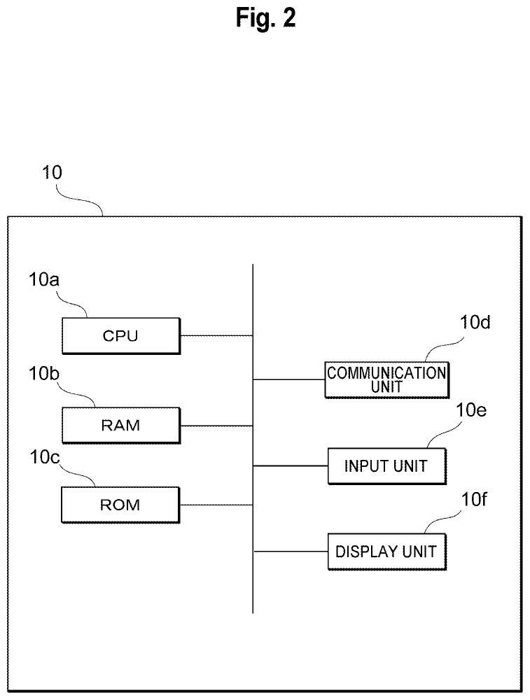

FIG. 2 is a diagram illustrating an example of a physical configuration of the information processing device 10 according to the embodiment. The information processing device 10 has one or a plurality of CPUs (Central Processing Units) 10a corresponding to an arithmetic unit, a RAM (Random Access Memory) 10b corresponding to a storage unit, a ROM (Read Only Memory) 10c corresponding to the storage unit, a communication unit 10d, an input unit 10e, and a display unit 10f. These individual components are connected via a bus to be capable of mutual data transmission/reception.

In the present embodiment, a description will be given of a case where the information processing device 10 is configured to include one computer, but the information processing device 10 may also be implemented by combining a plurality of computers or a plurality of arithmetic units with each other. Note that the components illustrated in FIG. 1 are exemplary, and the information processing device 10 may also have a component other than these or may not have any of these components.

The CPU 10a is an example of a processor, and is a control unit that performs control related to execution of a program stored in the RAM 10b or the ROM 10c and an arithmetic operation and processing of data. The CPU 10a is, e.g., an arithmetic unit that executes a program (learning program) of performing learning by using a predetermined learning model. The CPU 10a receives various data from the input unit 10e and the communication unit 10d, displays a result of the arithmetic operation of data on the display unit 10f, and stores the arithmetic operation result in the RAM 10b.

In the storage unit, data rewriting can be performed to the RAM 10b, and the RAM 10b may be configured to include, e.g., a semiconductor storage element. The RAM 10b may also store the program to be executed by the CPU 10a, individual learning models, data related to parameters of the individual learning models, data related to feature values of learning target data, data representing correspondence relationships between these feature values and the significant data expansion algorithms, or the like. Note that these are exemplary, and the RAM 10b may also store data other than these or may not store any of these.

In the storage unit, data can be read from the ROM 10c, and the ROM 10c may be configured to include, e.g., a semiconductor storage element. The ROM 10c may store, e.g., a learning program or data not to be rewritten.

The communication unit 10d is an interface connecting the information processing device 10 to another device. The communication unit 10d may be connected to a communication network such as the Internet.

The input unit 10e receives a data input from the user, and may include, e.g., a keyboard and a touch panel.

The display unit 10f visually displays results of the arithmetic operations by the CPU 10a, and may be configured to include, e.g., an LCD (Liquid Crystal Display). The display of the arithmetic operation result by the display unit 10f may contribute to an XAI (eXplainable AI: explainable AI). The display unit 10f may also display, e.g., a learning result or data related to learning.

The learning program may be stored on a computer-readable non-transitory storage medium such as the RAM 10b or the ROM 10c and provided or may also be provided via the communication network connected via the communication unit 10d. In the information processing device 10, the CPU 10a executes the learning program to implement various operations described with reference to FIG. 2 described later. Note that these physical components are exemplary, and need not necessarily be independent components. For example, the information processing device 10 may also include an LSI (Large-Scale Integration) in which the CPU 10a, the RAM 10b, and the ROM 10c are integrated. Alternatively, the information processing device 10 may also include a GPU (Graphical Processing Unit) or an ASIC (Application Specific Integrated Circuit).

Note that components of the information processing device 20 are the same as the components of the information processing device 10 illustrated in FIG. 2, and therefore a description thereof is omitted. The information processing device 10 and the information processing device 20 may appropriately have the CPU 10a, the RAM 10b, and the like which are basic components that perform data processing, and the input unit 10e and the display unit 10f may not be provided. Alternatively, the input unit 10e and the display unit 10f may also be connected from the outside by using the interface.

Processing Configuration

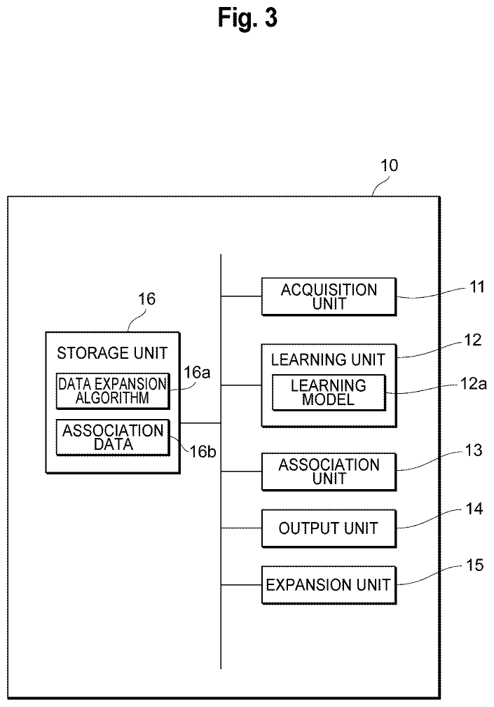

FIG. 3 is a diagram illustrating an example of processing blocks of the information processing device (server) 10 according to the embodiment. The information processing device 10 includes an acquisition unit 11, a learning unit 12, an association unit 13, an output unit 14, an expansion unit 15, and a storage unit 16. The information processing device 10 may also be configured to include a versatile computer.

The acquisition unit 11 acquires, from the information processing device 20, the expanded data resulting from the expansion of the target data using an optional data expansion algorithm. For example, when the target data is image data, the acquisition unit 11 acquires one or a plurality of expanded data items resulting from the expansion of the target data using the data expansion algorithm such as inversion, brightness change, rotation, parallel shift, or synthesis.

Alternatively, the acquisition unit 11 may also acquire the target data from the information processing device 20. In this case, it may also be possible that the target data acquired from the information processing device 20 is subjected to data expansion using the optional data expansion algorithm by the expansion unit 15 described later, and the acquisition unit 11 acquires the expanded data resulting from expansion by the expansion unit 15.

The target data is the learning target data and includes at least any of, e.g., the image data, serial data, and text data. The image data includes herein data on a still image and data on a moving image. The serial data includes voice data, stock price data, and the like.

When the target data is the image data, the data expansion algorithm may also include, e.g., a predetermined adversarial sample generation algorithm. A specific example of the data expansion algorithm may be any one of known FGSM (Fast Gradient Sign Method), DeepFool, IGSM (Iterative Gradient Sign Method), C&W (Carlini & Wagner), and JSMA (Jacobian-Based Saliency Map Approach) or an optional combination of the algorithms. Alternatively, the data expansion algorithm may be an algorithm that performs one-pixel attack, and the one-pixel attack may also be further performed with respect to the image data generated by the method described above. Still alternatively, the data expansion algorithm may also be another algorithm that generates an adversarial image by using a generative adversarial network such as GANs (Generative adversarial networks). Note that known adversarial sample generation algorithms including the examples mentioned above may also include an adversarial sample generation algorithm to be known in future.

When the target data is the image data, the data expansion algorithms may also include a predetermined algorithm that adds a change to at least a part of the image data. In a specific example, the data expansion algorithm includes at least one of the following known editing methods. It is appropriate that, when the data expansion is to be performed, it is set to add a predetermined amount of editing according to any of the editing methods.

Shift image horizontally and/or vertically

Invert image in horizontal direction and/or vertical direction

Rotate (rotation angle is random)

Change brightness

Perform zoom-in or zoom-out

Hollow out or delete part of image

Change background color

Replace Background

Mixup or CutMix

Change color space model

When the target data is the serial data, the data expansion algorithms include, e.g., a method that performs frequency conversion to conduct filtering. When the target data is the text data, the data expansion algorithms include, e.g., a method that uses morpheme analysis, TF/IDF, or the like to cut an item with a high appearance frequency or an item with a low appearance frequency or an item with a high appearance frequency. The data expansion algorithms may also include another algorithm that modifies the target data.

As a result, it is possible to efficiently expand the target data in advance by using the data expansion algorithm. In addition, by using the algorithms described above, it is possible to automatically expand the learning data and facilitate processing of expanding the learning data. The data expansion algorithms may also be sorted out according to a purpose of the data expansion. For example, when a first function library obtained by getting together the adversarial sample generation algorithms and a second function library obtained by getting together image editing algorithms are generated, the user can perform the data expansion according to the purpose by specifying the function library. Specifically, when the learning model is generated to counteract the generative adversarial algorithm, the first function library may be selected appropriately and, when slight modification is added to the target data to increase the training data, the second function library may be selected appropriately.

The learning unit 12 inputs the expanded data acquired by the acquisition unit 11 to the learning model 12a that performs predetermined learning to implement learning. A type of the learning may be determined appropriately on the basis of the target data, a problem to be solved, or the like. For example, the learning model 12a is a learning model to be used as a weak learner, and any of learning models such as a decision tree classification model, a K-means classification model, a logistic regression classification model, a statistical model, and the like is applicable thereto. The learning unit 12 can also apply, to the learning model 12a, any of a random forest using bagging and a decision tree, XGboost using boosting and a decision tree, a learning model using a relatively simple neural network, and the like.

The learning unit 12 may also use a predetermined learning model using a neural network, which can be applied to a strong learner. The predetermined learning model 12a includes at least one of, e.g., an image recognition model, a serial data analysis model, a robot control model, a reinforced learning model, a voice recognition model, a voice generation model, an image generation model, a natural language processing model, and the like. A specific example of the predetermined learning model 12a may also be any of a CNN (Convolutional Neural Network), a RNN (Recurrent Neural Network), a DNN (Deep Neural Network), a LSTM (Long Short-Term Memory), a bidirectional LSTM, a DQN (Deep Q-Network), a VAE (Variational AutoEncoder), GANs (Generative Adversarial Networks), a flow-based generation model, and the like.

The learning model 12a also includes a model obtained by performing pruning, quantization, distillation, or transfer with respect to the learned model. Note that these are only exemplary, and the learning unit 12 may also implement machine learning by the learning model for a problem other than these.

For example, when it is assumed that the target data is the image data and the learning model 12a is the CNN, the learning unit 12 is assumed to solve a classification problem of whether or not a target object in an image is correctly classified. The learning unit 12 inputs the image data to the learning model 12a and outputs, as a learning result, whether or not the target object in the image data can correctly be recognized.

When the learning result of the learning in the learning unit 12 indicates an intended result, the association unit 13 associates information related to the target data with information related to the optional data expansion algorithm. For example, when the learning result of the classification problem is output and when the classification result of the expanded data indicates correct classification, the association unit 13 associates feature information of the target data with identification information of the data expansion algorithm that has generated the expanded data indicating the correct classification result. Note that, when the classification result of the expanded data indicates incorrect classification, association processing may also be performed. In addition, the significant data expansion algorithm may also be associated, together with the classification result (such as a correct answer or an incorrect answer), with the target data.

According to the foregoing processing, the server 10 can associate the significant data expansion algorithms with various target data items, assign the same label as that of the target data to the generated expanded data, and reduce the burden of the annotation. In addition, the association unit 13 can also automatically associate (assign) the label of the target data with (to) the expanded data.

The output unit 14 outputs, in response to a predetermined request, association data obtained by associating the information related to the target data with the information related to the data expansion algorithm, information related to the significant data expansion algorithm corresponding to the target data, the information related to the target data corresponding to the data expansion algorithm, or the like to the information processing device 20 or the like.

The expansion unit 15 performs the expansion of the target data by using the optional data expansion algorithm. For example, the expansion unit 15 uses any of the data expansion algorithms mentioned above to generate the expanded data of the target data such as the image data or the serial data. The expansion unit 15 may also change parameters of the function of the data expansion algorithm to generate a plurality of expanded data items. Note that the expansion unit 15 is not necessarily a required component of the server 10.

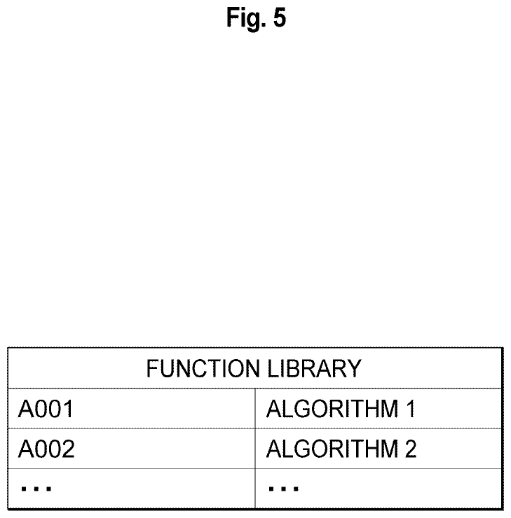

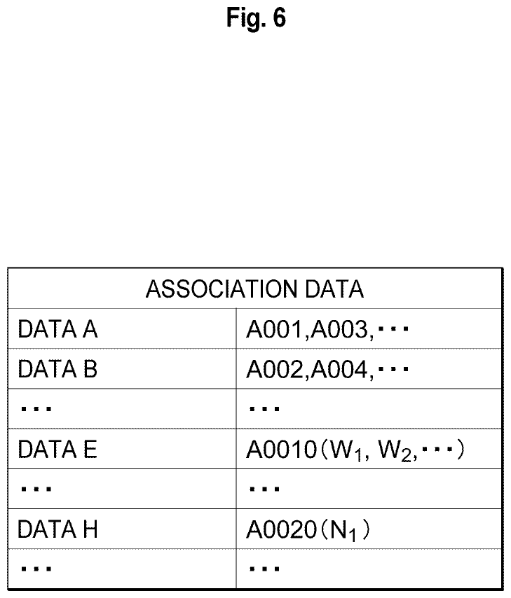

The storage unit 16 stores one or a plurality of data expansion algorithms 16a and association data 16b (e.g., FIG. 6) which is a collection of a predetermined number or more of data items. As illustrated in FIG. 5 described later, the data expansion algorithm 16a may also be stored as a function library which is a set of associated data expansion algorithms.

The optional data expansion algorithm may also include a coupled function obtained by coupling together a plurality of data expandable functions by using weights. For example, the coupled function is obtained by giving respective weights to the individual functions and linearly coupling the functions, and a total of the individual weights is assumed to be 1. At this time, it is assumed that the expansion unit 15 sequentially changes the individual weights according to a predetermined criterion.

In this case, the learning unit 12 may also include implementing learning by using the individual expanded data items generated by stepwise changing a weight of the coupled function. Every time the weight is changed, the learning unit 12 inputs, to the learning model 12a, the expanded data generated by using the coupled function having the changed weight and obtains the learning result.

When the learning result is obtained every time the weight is changed, the association unit 13 may also include specifying a boundary weight with which the learning result of the learning indicates an intended result and associating the boundary weight with the information related to the target data. For example, when the weight is sequentially changed, the boundary weight refers to a weight before a weight with which the classification result indicates a first result (e.g., a correct answer) switches to a weight with which the classification result indicates a second result (e.g., an incorrect answer) different from the first result. In a specific example, when the weight is sequentially changed to W₁ (which may also be a set of a plurality of weights), W₂, and W₃ and the classification result indicates the correct answer up to Wₙ, but the classification result indicates the incorrect answer with Wₙ₊₁, Wₙ is assumed to be the boundary weight. Note that the boundary weight is an example of the information related to the data expansion algorithm.

According to the foregoing processing, when the data expansion algorithm includes the coupled function, it is possible to find, for each item of the target data, a boundary value of the weight of the coupled function, generate, for the target data item, various coupled functions by appropriately changing the weight up to the boundary value, and increase the expanded data by using these significant coupled functions.

The optional data expansion algorithm may also include a function that can be subjected to integral order or factional order differentiation or integration. For example, the expansion unit 15 may also perform, with respect to a predetermined function, integral order differentiation by a predetermined order, then perform fractional order differentiation by a predetermined order, and further change the differentiation to the integration to generate various functions.

In this case, the learning unit 12 may also include implementing learning by using the individual expanded data items generated by stepwise changing an integral order or fractional order of the function. For example, every time the integral order or fractional order of the differentiation or the integration is stepwise changed, the learning unit 12 uses the changed function to input the generated expanded data to the learning model 12a and obtain the learning result.

When the learning result is obtained every time the integral order or fractional order of the differentiation or the integration is changed, the association unit 13 may also include specifying a boundary integral order or fractional order with which a learning result of the predetermined learning indicates an intended result and associating the boundary integral order or factional order with the information related to the target data. For example, when the order is sequentially changed, the boundary integral order or fractional order refers to an order when the order with which the classification result indicates the first result (e.g., the correct answer) switches to the order with which the classification result indicates the second result (e.g., the incorrect answer) different from the first result. In a specific example, when the order is sequentially changed to N₁ (order), N₂, and N₃ and when the classification result indicates the correct answer up to Nₙ, but the classification result becomes incorrect with Nₙ₊₁, Nₙ is assumed to be the boundary order. Note that the boundary order is an example of the information related to the data expansion algorithm.

According to the foregoing processing, when the data expansion algorithm includes the function that can be differentiated or integrated, it is possible to find, for each item of the target data, a boundary value of the order of the differentiation or the integration, generate various functions for the target data item by appropriately changing the order up to the boundary value, and increase the expanded data by using these significant functions.

The target data may also be at least one data item in a predetermined data set. In this case, the association unit 13 may also include associating feature information of the predetermined data set with the information related to the optional data expansion algorithms. For example, the feature information of the data set includes information related to genres or categories of the image data, the serial data, and the like, information related to types in a given category, and the like. In the case of, e.g., the image data, the information related to the types includes animal, vehicle, living body information or the like and, in the case of the serial data, the information related to the types includes sounds, stock prices, or the like. Note that the feature information of the data set is an example of the information related to the target data.

According to the foregoing processing, by associating the feature information of the data set with the information related to the significant data expansion algorithms, when features of a given data set are acquired, it is possible to specify the significant data expansion algorithms for the data set. In addition, it is possible to generate a library including the data set and the one or plurality of significant data expansion algorithms.

When the learning result from the learning unit 12 is represented by a numerical value indicating the intended result, the association unit 13 may also include associating information related to the optional data expansion algorithm with which the numerical value falls within a predetermined range related to the intended result with the information related to the target data. For example, when the predetermined learning is learning of the classification problem, it is possible to represent the learning result with a numerical value from 0 to 1 by using a sigmoid function or the like and provide a criterion such that, e.g., when the numerical value is equal to or more than 0.5, the learning result indicates the correct answer and, when the numerical value is less than 0.5, the learning result indicates the incorrect answer. In this case, for example, when the learning result falls within a range of 0.7 to 1.0, the association unit 13 may also associate the information related to the data expansion algorithm that has generated the expanded data with the information related to the target data. Note that, when the learning result falls within the predetermined range, the association unit 13 may also associate the above-mentioned weight or order serving as a boundary within the predetermined range with the information related to the target data.

According to the foregoing processing, it is possible to provide a clearer criterion for the association and, by appropriately changing the predetermined range, it is possible to associate, with the target data, the data expansion algorithm that has generated the expanded data with which the intended learning result set by the user is obtained. The intended learning result may also include a result set by the user from among a plurality of results including the correct answer or the incorrect answer to a predetermined learning problem.

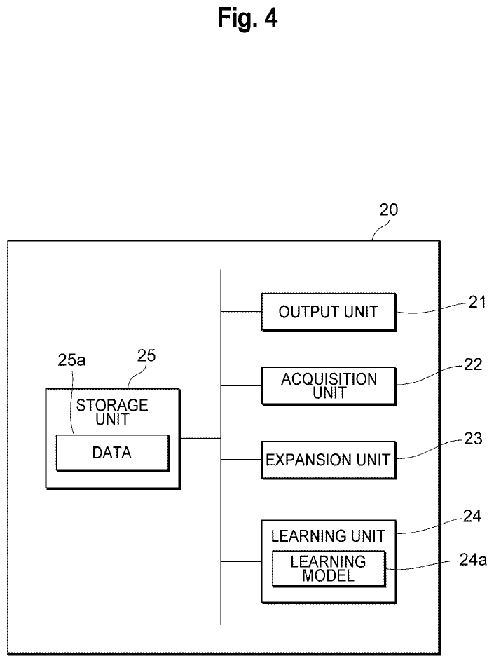

FIG. 4 is a diagram illustrating an example of processing blocks of the information processing device 20 according to the embodiment. The information processing device 20 includes an output unit 21, an acquisition unit 22, an expansion unit 23, a learning unit 24, and a storage unit 25. The information processing device 20 may also be configured to include a versatile computer.

The output unit 21 outputs the information related to the target data to another information processing device. For example, the output unit 21 outputs the learning target data to the server 10. Note that the output unit 21 may also output feature information of the learning target data to the server 10.

From among the plurality of data expansion algorithms, the data expansion algorithm associated with the information related to the target data is specified by the other information processing device, and the acquisition unit 22 acquires, from the other information processing device, the information related to the specified data expansion algorithm. For example, the acquisition unit 22 acquires, from the server 10, the information related to the data expansion algorithm specified by the server 10 on the basis of the information related to the learning target data. The information related to the data expansion algorithm may be the data expansion algorithm itself, or may also be information that identifies the data expansion algorithm.

The expansion unit 23 applies, to the target data, the data expansion algorithm based on the information related to the data expansion algorithm specified by the other information processing device to perform data expansion. For example, the expansion unit 23 applies the learning target data to the data expansion algorithm specified by the server 10 to generate the expanded data. Note that the expansion unit 23 has the same function as that of the expansion unit 15 of the server 10.

The learning unit 24 inputs the learning target data and the expanded data to a learning model 24a that performs predetermined learning to implement learning. The learning unit 24 may also feedback, to the server 10, a learning result after the learning. The learning result may also include, e.g., hyper parameters after adjustment, learning accuracy, and the like. The learning unit 24 may also select the learning model 24a on the basis of a type of the target data and/or a problem to be solved.

The predetermined learning model 24a is a learning model including a neural network and includes at least one of, e.g., an image recognition model, a serial data analysis model, a robot control model, a reinforced learning model, a voice recognition model, a voice generation model, an image generation model, a natural language processing model, and the like. In a specific example, the predetermined learning model 24a may also be any of a CNN (Convolutional Neural Network), a RNN (Recurrent Neural Network), a DNN (Deep Neural Network), a LSTM (Long Short-Term Memory), a bidirectional LSTM, a DQN (Deep Q-Network), a VAE (Variational AutoEncoder), GANs (Generative Adversarial Networks), a flow-based generation model, and the like.

The learning model 24a also includes a model obtained by performing pruning, quantization, distillation, or transfer with respect to the learned model. Note that these are only exemplary, and the learning unit 24 may also implement machine learning by the learning model for a problem other than these.

The storage unit 25 stores data related to the learning unit 24. The storage unit 25 stores data 25a including the learning target data, the expanded data, the data acquired from the server 10, data being learned, and the like.

Thus, the information processing device 20 receives, from the server 10, a notification of the significant data expansion algorithms for the target data to be able to generate the expanded data having the same features as those of the target data. In addition, by using the expanded data, the information processing device 20 can efficiently increase the number of training data items and improve the accuracy of the learning model.

### Data Example

FIG. 5 is a diagram illustrating an example of a function library according to the embodiment. In the example illustrated in FIG. 5, the functions of the data expansion algorithms are associated with individual identification information items (ID) of the functions. For example, with a function ID “A001”, the function of performing shift conversion may be associated while, with a function ID “A002”, the function of performing enlargement or reduction may be associated. Alternatively, with the function IDs, groups of functions may also be associated. Examples thereof include a group of functions related to image editing, generative adversarial algorithms, and the like. Still alternatively, with the function IDs, the above-mentioned coupled functions and functions to be subjected to the integral order or fractional order differentiation or integration may also be associated. There may also be a function library including, for individual types of the target data items, the corresponding data expansion algorithms.

The expansion unit 15 of the server 10 or the expansion unit 23 of the information processing device 20 selects a predetermined function from among the functions included in the function library illustrated in FIG. 5 to generate the expanded data.

FIG. 6 is a diagram illustrating an example of the association data of the information related to the target data and the information related to the significant data expansion algorithms according to the embodiment. In the example illustrated in FIG. 6, with “DATA A” indicating a type of data, the plurality of significant data expansion algorithms of the function IDs “A001”, “A003”, and the like are associated. With “DATA E” indicating a type of data, boundary values (W₁, W₂, . . . ) of individual weights of a function ID “A0010” are associated while, with “DATA H” indicating a type of data, a boundary value (N₁) of an integral order or fractional order of a function ID “A0020” is associated.

Example of Use of Predetermined Range

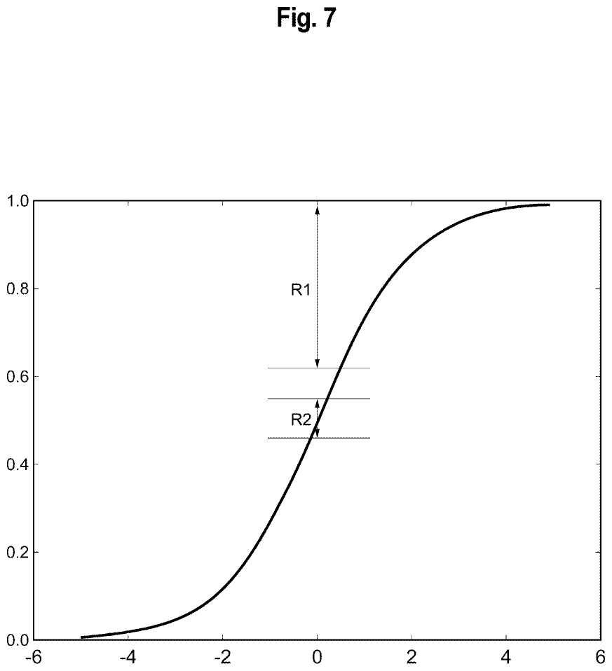

FIG. 7 is a diagram illustrating an example of a predetermined range according to the embodiment. In the example illustrated in FIG. 7, the learning result is output from the learning unit 12 by using the sigmoid function. It is assumed that the learning result having a value closer to 1.0 has higher classification accuracy. At this time, a predetermined range R1 allows the learning result having high classification accuracy to be automatically extracted and, to the expanded data included in the predetermined range R1, the same correct answer label as that of the target data can automatically be assigned. Note that the predetermined range R1 may also be a predetermined range from 0 and, in this case, an incorrect answer label is assigned to the expanded data.

A predetermined range R2 is a predetermined range including a median value of 0.5, and classification based on learning may not have appropriately been performed. The expanded data included in the predetermined range R2 is extracted, and the extracted expanded data may manually be labeled. For example, the data expansion algorithm that has generated the misclassified expanded data may also be excluded from association targets of the target data. This allows the data expansion algorithm that generates the expanded data prone to misclassification to be excluded from the association targets.

### Processing Example

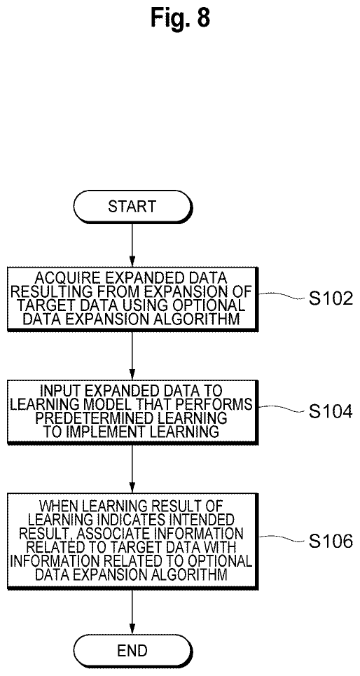

FIG. 8 is a flow chart illustrating an example of processing by the server 10 according to the embodiment. In Step S102, the acquisition unit 11 of the server 10 acquires the expanded data resulting from the expansion of the target data using the optional data expansion algorithm. Alternatively, the acquisition unit 11 of the server 10 may also receive the target data from the information processing device 20. When receiving the target data, the server 10 may also cause the expansion unit 15 to generate the expanded data, and the acquisition unit 11 may also acquire the expanded data resulting from the expansion by the expansion unit 15.

In Step S104, the learning unit 12 of the server 10 inputs the expanded data to the learning model 12a that performs the predetermined learning to implement learning. The predetermined learning may also be selected appropriately on the basis of the target data. For example, when the target data is the image data, the predetermined learning is learning of solving a classification problem and, when the target data is the serial data, the predetermined learning is learning of performing clustering.

In Step S106, when the learning result of the learning indicates the intended result, the association unit 13 of the server 10 associates the information related to the target data with the information related to the optional data expansion algorithm. For example, the intended result is any of, e.g., a case where a classification is made to the same category as that of the label assigned to the target data, a case where a classification is made to a different category, a case where a classification is made to a predetermined range prone to misclassification, and the like. The intended result may also be set by the user.

Thus, according to the processing by the server 10 according to the embodiment, by associating the significant data expansion algorithms with each item of data, it is possible to provide, for the predetermined data, the significant data expansion algorithms.

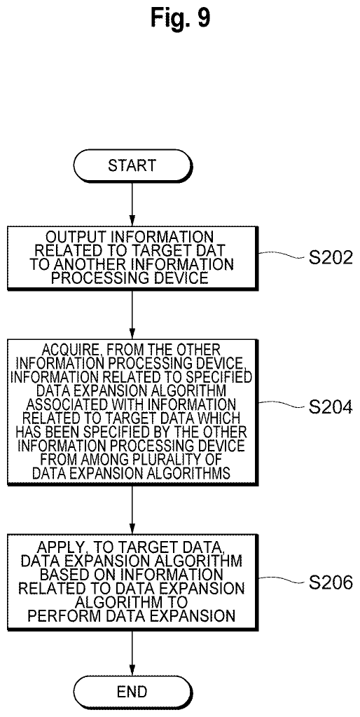

Next, a description will be given of the user-side information processing device 20. FIG. 9 is a flow chart illustrating an example of processing by the information processing device 20 according to the embodiment. In Step S202, the output unit 21 of the information processing device 20 outputs the information related to the target data to the other information processing device. For example, the output unit 21 outputs the learning target data or the feature information of the learning target data to the server 10.

In Step S204, from among the plurality of data expansion algorithms, the data expansion algorithm associated with the information related to the target data is specified by the other information processing device, and the acquisition unit 22 of the information processing device 20 acquires, from the other information processing device, information related to the specified data expansion algorithm. For example, the acquisition unit 22 acquires, from the server 10, the information related to the significant data expansion algorithms associated with the target data.

In Step S206, the expansion unit 23 of the information processing device 20 applies, to the target data, the data expansion algorithm based on the information related to the data expansion algorithm specified by the server 10 to perform data expansion. For example, the expansion unit 23 inputs the target data to the significant data expansion algorithm to generate the expanded data.

In a case where the intended learning result is the correct answer learning result, the expansion unit 23 may also assign the label of the target data to the expanded data. In a case where the intended learning result is an incorrect answer result, the expansion unit 23 may also assign a label (e.g., an incorrect answer label) different from the label of the target data.

The learning unit 24 of the information processing device 10 uses the target data and the expanded data as the training data to perform supervised learning. As the learning model 24a of the learning unit 24, an appropriate model may be set appropriately according to the target data or a purpose. By increasing the number of the training data items, it is possible to improve the accuracy of the learning model 24a.

Thus, according to the information processing device 10 according to the embodiment, it is possible to know the significant data expansion algorithms for the target data and perform the data expansion to generate the intended expanded data. As a result, the information processing device 10 can efficiently increase the training data and improve the accuracy of the learning model. In addition, it is possible to save the user the labor resulting from labeling.

Thus, the embodiments are intended to facilitate understanding of the present invention and should not be construed to limit the present invention. Constituent elements included in the embodiments and arrangements, materials, conditions, shapes, sizes, and the like thereof are not limited to those exemplified and can appropriately be modified. It is also possible to partially substitute or combine configurations described in the different embodiments.

In the embodiments described above, the learning unit 24 of the information processing device 10 may also be implemented in another device and, in this case, the information processing device 10 may also transmit the expanded data to the other device.

The embodiments described above disclose the following notes.

### Note 1

An information processing method performed by a processor included in an information processing device, the method including:

acquiring expanded data resulting from expansion of target data using an optional data expansion algorithm;

inputting the expanded data to a learning model that performs predetermined learning to implement learning; and

performing, when a learning result of the learning indicates an intended result, association of information related to the target data with information related to the optional data expansion algorithm, the intended result being a result set by a user from among a plurality of results including a correct answer and an incorrect answer to a problem of the predetermined learning.

### Note 2

The information processing method according to Note 1, wherein

the optional data expansion algorithm includes a coupled function obtained by coupling together a plurality of data expandable functions by using weights,

the learning includes implementing learning by using each item of the expanded data generated by stepwise changing a weight of the coupled function, and

the association includes specifying a boundary weight with which the learning result of the learning indicates the intended result and associating the boundary weight with the information related to the target data.

### Note 3

The information processing method according to Note 1, wherein

the optional data expansion algorithm includes a function that can be subjected to integral order or fractional order differentiation or integration, the learning includes implementing learning by using each item of the expanded data generated by stepwise changing an integral order or fractional order of the function, and

the association includes specifying a boundary integral order or fractional order with which the learning result of the learning indicates the intended result and associating the boundary integral order or fractional order with the information related to the target data.

### Note 4

The information processing method according to any one of Notes 1 to 3, wherein

the target data is data in a predetermined data set, and

the association includes associating feature information of the predetermined data set with the information related to the optional data expansion algorithm.

### Note 5

The information processing method according to any one of Notes 1 to 4, wherein,

when the learning result is represented by a numerical value indicating the intended result, the association includes associating, with the information related to the target data, the information related to the optional data expansion algorithm with which the numerical value falls within a predetermined range related to the intended result.

### Note 6

A non-transitory recording medium recording thereon a program that causes a processor included in an information processing device to:

acquire expanded data resulting from expansion of target data using an optional data expansion algorithm;

input the expanded data to a learning model that performs predetermined model to implement learning; and

perform, when a learning result of the learning indicates an intended result, association of information related to the target data with information related to the optional data expansion algorithm.

### Note 7

An information processing device including:

a processor,

the processor acquiring expanded data resulting from expansion of target data using an optional data expansion algorithm,

the processor inputting the expanded data to a learning model that performs predetermined learning to implement learning,

the processor performing, when the learning result of the learning indicates an intended result, association of information related to the target data with information related to the optional data expansion algorithm.

### Note 8

An information processing method performed by a processor included in an information processing device, the method including:

outputting information related to target data to another information processing device;

acquiring, from the other information processing device, information related to a specified data expansion algorithm associated with the information related to the target data which has been specified by the other information processing device from among a plurality of data expansion algorithms; and

applying, to the target data, the data expansion algorithm based on the information related to the data expansion algorithm to perform data expansion.

### Note 9

A non-transitory recording medium storing thereon a program that causes a processor included in an information processing device to:

output information related to target data to another information processing device; and

acquire, from the other information processing device, information related to a specified data expansion algorithm associated with the information related to the target data which has been specified by the other information processing device from among a plurality of data expansion algorithms.

### Note 10

An information processing device including:

a processor,

the processor outputting information related to target data to another information processing device,

the processor acquiring, from the other information processing device, information related to a specified data expansion algorithm associated with the information related to the target data which has been specified by the other information processing device from among a plurality of data expansion algorithms,

the processor applying, to the target data, the data expansion algorithm based on the information related to the data expansion algorithm to perform data expansion.

### Note 11

An information processing method in an information processing device including a memory and one or a plurality of processors, the method including:

the memory storing therein a learning model that performs predetermined learning by using a neural network;

the one or plurality of processors acquiring expanded data resulting from expansion of target data using an optional data expansion algorithm including a function that can be subjected to integral order or fractional order differentiation or integration;

the one or plurality of processors inputting, to the learning model, each item of the expanded data generated by stepwise changing an integral order or fractional order of the function to implement learning; and

the one or plurality of processors specifying a boundary integral order or fractional order with which a learning result of the learning indicates an intended result and associating the boundary integral order or fractional order with information related to the target data.

### Note 12

A non-transitory recording medium recording thereon a program that causes a processor included in an information processing device having a memory storing therein a learning model that performs predetermined learning by using a neural network to:

acquire expanded data resulting from expansion of target data using an optional data expansion algorithm including a function that can be subjected to integral order or fractional order differentiation or integration;

input, to the learning model, each item of the expanded data generated by stepwise changing an integral order or fractional order of the function to implement learning; and

specify a boundary integral order or fractional order with which a learning result of the learning indicates an intended result and associate the boundary integral order or fractional order with information related to the target data.

### Note 13

An information processing device including:

a memory; and

one or a plurality of processors,

the memory storing therein a learning model that performs predetermined learning by using a neural network,

the one or plurality of processors acquiring expanded data resulting from expansion of target data using an optional data expansion algorithm including a function that can be subjected to integral order or fractional order differentiation or integration,

the one or plurality of processors inputting, to the learning model, each item of the expanded data generated by stepwise changing an integral order or fractional order of the function to implement learning,

the one or plurality of processors specifying a boundary integral order or fractional order with which a learning result of the learning indicates an intended result and associating the boundary integral order or fractional order with information related to the target data.

What is claimed is:

1. An information processing method in an information processing device including a memory and one or a plurality of processors, the method comprising:
the memory storing therein a learning model that performs predetermined learning by using a neural network;
the one or plurality of processors acquiring expanded data resulting from expansion of target data using an optional data expansion algorithm including a coupled function obtained by coupling together a plurality of data expandable functions by using weights;
the one or plurality of processors inputting, to the learning model, each item of the expanded data generated by stepwise changing a weight of the coupled function to implement learning; and
the one or plurality of processors specifying a boundary weight with which a learning result of the learning indicates an intended result and associating the boundary weight with information related to the target data.

2. The information processing method according to claim 1, wherein, when the learning result of the learning indicates the intended result, the one or plurality of processors assign, to the expanded data, the same label as a label assigned to the target data.

3. The information processing method according to claim 1, wherein, when the predetermined learning is learning of a classification problem and the learning result indicates a classification result, the association includes specifying, as the boundary weight, a weight when a result of the classification changes from a first result to a second result.

4. A computer-readable non-transitory recording medium recording thereon a program that causes one or a plurality of processors included in an information processing device having a memory storing therein a learning model that performs predetermined learning by using a neural network to:
acquire expanded data resulting from expansion of target data using an optional data expansion algorithm including a coupled function obtained by coupling together a plurality of data expandable functions by using weights;
input, to the learning model, each item of the expanded data generated by stepwise changing a weight of the coupled function to implement learning; and
specify a boundary weight with which a learning result of the learning indicates an intended result and associate the boundary weight with information related to the target data.

5. The recording medium according to claim 4, wherein, when the learning result of the learning indicates the intended result, the one or plurality of processors are caused to assign, to the expanded data, the same label as a label assigned to the target data.

6. The recording medium according to claim 4, wherein, when the predetermined learning is learning of a classification problem and the learning result indicates a classification result, the association includes specifying, as the boundary weight, a weight when the classification result changes from a first result to a second result.

7. An information processing device comprising:
a memory; and
one or a plurality of processors,
the memory storing therein a learning model that performs predetermined learning by using a neural network,
the one or plurality of processors acquiring expanded data resulting from expansion of target data using an optional data expansion algorithm including a coupled function obtained by coupling together a plurality of data expandable functions by using weights,
the one or plurality of processors inputting, to the learning model, each item of the expanded data generated by stepwise changing a weight of the coupled function to implement learning, and
the one or plurality of processors specifying a boundary weight with which a learning result of the learning indicates an intended result and associating the boundary weight with information related to the target data.

8. The information processing device according to claim 7, wherein, when the learning result of the learning indicates the intended result, the one or plurality of processors assign, to the expanded data, the same label as a label assigned to the target data.

9. The information processing device according to claim 7, wherein, when the predetermined learning is learning of a classification problem and the learning result indicates a classification result, the association includes specifying, as the boundary weight, a weight when a result of the classification changes from a first result to a second result.
